(19) United States
(12) Patent Application Publication
(10) Pub. No.: US 2026/0023592 A1
(43) Pub. Date: Jan. 22, 2026

(54) ADJUSTING ADAPTIVE WORKERS INCREASE FOR WAITING SITUATIONS

(71) Applicant: SAP SE, Walldorf (DE)

(72) Inventors: Christina Teflioudi, Heidelberg (DE); Paul Willems, Heidelberg (DE); Marius Eich, Neustadt (DE)

(21) Appl. No.: 18/776,083

(22) Filed: Jul. 17, 2024

(51) Int. Cl. G06F 9/48; G06F 9/52

(52) U.S. Cl. CPC G06F 9/4818; G06F 9/524

(57) ABSTRACT

Arrangements for adjusting adaptive workers increase for waiting situations are provided. A number of tasks that have been processed since a last check of periodic checks into a task queue may be determined. In response to determining that a progress threshold has not been reached, determining, for a thread working in the task queue, a thread active time and an elapsed time. The thread active time may include an accumulated time the thread was actively executing a task since the last check of the periodic checks into the task queue. The elapsed time may include an amount of time that has passed since the last check of periodic checks into a task queue. A ratio of the thread active time and the elapsed time may be determined. A number of threads for executing the task queue may be adaptively configured based on the ratio.

### TECHNICAL FIELD

The subject matter described herein relates generally to data processing and more specifically to adjusting adaptive workers increase for waiting situations.

### BACKGROUND

A task scheduling framework may decide a degree of parallelization and request resources based on progress checks. If not enough progress is made, it is often assumed that the reduced progress is due to tasks being CPU-intensive and that more resources are needed to work on the tasks. Thus, the task scheduling framework may request to double the number of resources or threads working on the tasks. The rate at which the number of threads are added may increase rapidly. In many cases, the lack of progress is not due to tasks being CPU-intensive, but due to waiting on locks or other synchronization primitives. Therefore, any additional threads may end up waiting on the same locks as already existing threads. Current task scheduling frameworks do not address this issue.

### SUMMARY

Methods, systems, and articles of manufacture, including computer program products, are provided for adjusting adaptive workers increase for waiting situations. In one aspect, there is provided a system including at least one processor and at least one memory. The at least one memory can store instructions that cause operations when executed by the at least one processor. The operations may include: determining a number of tasks that have been processed since a last check of periodic checks into a task queue; and in response to determining that a progress threshold has not been reached based on the number of tasks that have been processed: determining, for a thread working in the task queue, a thread active time comprising an accumulated time the thread was actively executing a task since the last check of the periodic checks into the task queue; determining, for the thread working in the task queue, an elapsed time since the last check of periodic checks into a task queue; determining a ratio of the thread active time and the elapsed time; and adaptively configuring a number of threads for executing the task queue based on the ratio.

In some variations, one or more of the features disclosed herein including the following features can optionally be included in any feasible combination. In some variations, adaptively configuring the number of threads for executing the task queue may include multiplying the ratio by a number of threads working in the task queue and a maximum workers factor.

In some variations, the maximum workers factor may be determined based on a progress that is made since the last check of periodic checks into the task queue.

In some variations, the maximum workers factor is two.

In some variations, the task queue may include a list of tasks with one or more threads to service the list.

In some variations, the thread active time may include a difference between the elapsed time since the last check of periodic checks into a task queue and a wait time.

In some variations, the operations may further include resetting the thread active time for the thread.

In some variations, one or more tasks in task queue may include a thread that is waiting on a lock.

In some variations, adaptively configuring the number of threads for executing the task queue may include requesting additional threads for executing the task queue.

In some variations, adaptively configuring a number of threads for executing the task queue may include keeping the number of threads as is.

In another aspect, there is provided a method for adjusting adaptive workers increase for waiting situations. The method may include: determining a number of tasks that have been processed since a last check of periodic checks into a task queue; and in response to determining that a progress threshold has not been reached based on the number of tasks that have been processed: determining, for a thread working in the task queue, a thread active time comprising an accumulated time the thread was actively executing a task since the last check of the periodic checks into the task queue; determining, for the thread working in the task queue, an elapsed time since the last check of periodic checks into a task queue; determining a ratio of the thread active time and the elapsed time; and adaptively configuring a number of threads for executing the task queue based on the ratio.

In some variations, one or more of the features disclosed herein including the following features can optionally be included in any feasible combination. In some variations, adaptively configuring the number of threads for executing the task queue may include multiplying the ratio by a number of threads working in the task queue and a maximum workers factor.

In some variations, the maximum workers factor may be determined based on a progress that is made since the last check of periodic checks into the task queue.

In some variations, the maximum workers factor is two.

In some variations, the task queue may include a list of tasks with one or more threads to service the list.

In some variations, the thread active time may include a difference between the elapsed time since the last check of periodic checks into a task queue and a wait time.

In some variations, the method may further include resetting the thread active time for the thread.

In some variations, one or more tasks in task queue may include a thread that is waiting on a lock.

In some variations, adaptively configuring the number of threads for executing the task queue may include requesting additional threads for executing the task queue.

In another aspect, there is provided a computer program product that includes a non-transitory computer readable medium. The non-transitory computer readable medium may store instructions that cause operations when executed by at least one processor. The operations may include: determining a number of tasks that have been processed since a last check of periodic checks into a task queue; and in response to determining that a progress threshold has not been reached based on the number of tasks that have been processed: determining, for a thread working in the task queue, a thread active time comprising an accumulated time the thread was actively executing a task since the last check of the periodic checks into the task queue; determining, for the thread working in the task queue, an elapsed time since the last check of periodic checks into a task queue; determining a ratio of the thread active time and the elapsed time; and adaptively configuring a number of threads for executing the task queue based on the ratio.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an illustrative computing environment for adjusting adaptive workers increase for waiting situations in accordance with some example embodiments;

FIG. 2 depicts a flowchart illustrating a process for adjusting adaptive workers increase for waiting situations in accordance with some example embodiments;

FIG. 3 depicts a timestamp graph illustrating a waiting situation in accordance with some example embodiments; and

FIG. 4 depicts a block diagram illustrating a computing system, in accordance with some example embodiments.

When practical, similar reference numbers denote similar structures, features, or elements.

### DETAILED DESCRIPTION

Aspects of the disclosure provide a technical solution that addresses problems associated with adjusting adaptive workers increase for waiting situations. For example, aspects of the disclosure accumulates the time the thread was actively running on the task every time a thread executes a task. When a check for progress is performed for threads worked on a queue, aspects of the disclosure reports back not just if the thread was working in the queue, but also how much time the thread was active since the last time a check was made. Additional aspects of the disclosure keeps track of how much time has passed since the last check and the thread active time for each thread. Advantageously, aspects of the disclosure may take into account the extent to which each thread actually worked within a time frame. These and various other arrangements will be discussed more fully below.

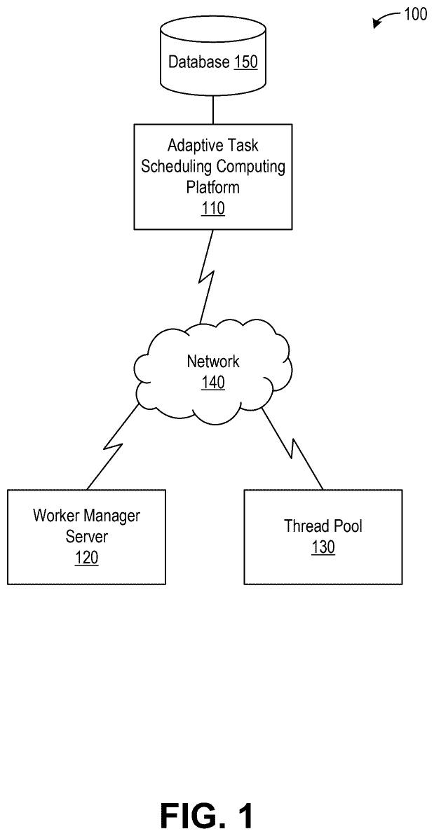

FIG. 1 depicts an illustrative computing environment 100 for adjusting adaptive workers increase for waiting situations in accordance with some example embodiments.

Referring to FIG. 1, the computing environment 100 may include one or more computing devices and/or other computing systems. For example, computing environment 100 may include an adaptive task scheduling computing platform 110, a worker manager server 120, a thread pool 130, and a database 150. Adaptive task scheduling computing platform 110 may include one or more computing devices configured to perform one or more of the functions described herein. For example, adaptive task scheduling computing platform 110 provides advanced ways to adjust adaptive workers increase for waiting situations.

Worker manager server 120 (e.g., also referred to as “WorkerManager”) may include one or more computing devices configured to perform one or more of the functions described herein. For example, a task scheduling framework may put the tasks into a queue. Worker manager server 120 may decide on a parallelization degree (e.g., how many threads or how many workers will be used to execute the tasks). In some examples, worker manager server 120 may manage a thread pool (e.g., thread pool 130) as a queue. Worker manager server 120 may add or adjust resources (threads) for working on tasks. A thread pool 130 may be and/or include a set of threads that can be used to execute parallel tasks. Once a thread in a thread pool completes a task, it may be returned to a queue of waiting threads. In some implementations, data such as thread active time data, manager between checks duration data, max workers factor data, and/or the like may be stored at worker manager server 120. For example, workers may maintain an accumulator of active time. This accumulator may be updated at the end of each task with an active time (e.g., elapsed time minus wait time) of the task. In addition, the accumulator may be updated each time the worker manager request the active time, the active time is handed over to the workers manager, and the accumulator is reset to be ready to accumulate times for a next interval.

Database 150 may include, for example, a relational database, an in-memory database, a graph database, a key-value store, a document store, and/or the like. In some examples, the adaptive task scheduling computing platform 110 may maintain (e.g., store) various types of data, including static and nonstatic data in database 150 coupled with the adaptive task scheduling computing platform 110.

Referring again to FIG. 1, the adaptive task scheduling computing platform 110, the worker manager server 120, the thread pool 130, and the database 150 may be communicatively coupled via a network 140. The network 140 may be a wired and/or wireless network including, for example, a wide area network (WAN), local area network (LAN), a virtual local area network (VLAN), the Internet, and/or the like. In some implementations, adaptive task scheduling computing platform 110 may be centralized, and workers managers and threads do not need to communicate through network 140.

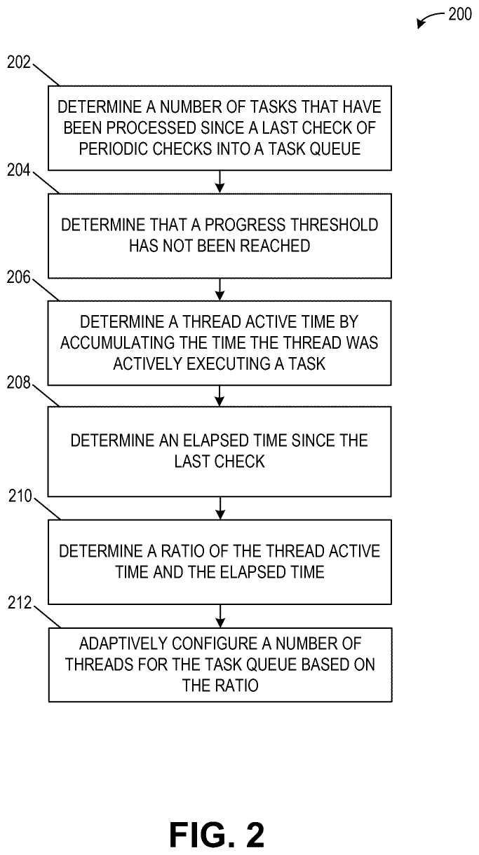

FIG. 2 depicts a flowchart 200 illustrating a process for adjusting adaptive workers increase for waiting situations in accordance with some example embodiments.

Referring to FIG. 2, at step 202, adaptive task scheduling computing platform 110 may determine a number of tasks that have been processed since a last check of periodic checks into a task queue. The task queue may include a list of tasks with one or more threads to service the list.

At step 204, adaptive task scheduling computing platform 110 may determine that a progress threshold (e.g., a minimum progress threshold) has not been reached based on the number of tasks that have been processed. In some example implementations, one or more tasks in task queue may include a thread that is waiting on a lock.

In some implementations, adaptive task scheduling computing platform 110 (e.g., via worker manager server 120) may use a separate thread which periodically looks inside the queue to see how many tasks there are. If worker manager server 120 sees that there is progress (e.g., the number of tasks gets reduced fast enough), it will not start or utilize more workers (or threads). On the other hand, if there is little or no progress (e.g., the number of tasks is not reduced fast enough), worker manager server 120 may decide to start some number of workers. Initially, there may be no workers at all. Worker manager server 120 may see some number of tasks and determine to start some default number of workers. Every time worker manager server 120 checks again, if there is not enough progress, worker manager server 120 may decide to increase the number of workers by some factor. This handling contains the assumption that if at some point in time it is determined that there is not enough progress, and the tasks take longer to be executed by the workers, the underlying reason is that the tasks in the queue are very CPU-intensive. Therefore, the assumed solution for this kind of task is to add CPU power (i.e., add extra workers). However, the task scheduling framework does not always know what is happening inside the task itself. For example, the task itself might contain a lock, a mutex, a semaphore, or the like, or the task might take a lot of time, not because the task is CPU-intensive, but because the worker or thread is simply waiting inside the lock. Aspects of the disclosure considers such waiting situations.

In this respect, referring to FIG. 2, at step 206, adaptive task scheduling computing platform 110 may determine, for a thread working in the task queue, a thread active time (e.g., thread_active_time or the time that the thread was active since the last time it was checked). At step 208, determine, for the thread working in the task queue, an elapsed time since the last check of checks into a periodic task queue (e.g., manager_between_checks_duration).

An active thread may include threads that are actually executing code or are ready to execute code. An inactive thread may include those that are blocked on I/O calls or awaiting locks, and may consume only memory resources without affecting the CPU (or marginally affecting the CPU). The thread active time may include an accumulated time the thread was actively executing a task since the last check of the periodic checks into the task queue. For example, adaptive task scheduling computing platform 110 may may determine, for every worker/thread the time that the thread was actually active (e.g., actually doing something) by subtracting the wait time (e.g., the wait time of a thread waiting in a lock) from the elapsed time (e.g., the elapsed time since the last check of periodic checks into a task queue). In this way, the contribution of every thread is weighted by an amount of time that the thread was actually active and not just waiting. In some examples, after a thread active time is reported, worker manager server 120 may reset the thread active time for the thread such that the time measurement starts anew the next time a check into the task queue is performed.

To illustrate further, assume a workers manager performs a check at timestamp C_cur and the previous check took place at timestamp C_prev. Assume the thread executes many tasks over its lifetime. The i-th task starts at t_{i, start} and ends at t_{i,end}. The elapsed time for the thread relevant for the check C_cur will be:

$$ElapsedTimeOfThread ( {C}_{prev} , {C}_{cur} ) = {\sum }_{i} ( max ( min ( {t}_{\{ i , end \}} , {C}_{cur} ) , {C}_{prev} ) - min ( max ( {t}_{\{ i , start \}} , {C}_{prev} ) , {C}_{cur} ) )$$

The max, mins exclude from the computations tasks that lie outside of the timeframe [C_prev, C_cur]. With respect to min (t (i,end), Ccur), if at the time C_cur a task is still running, the system takes Cour as end time. The sum is a sum over all tasks.

The wait time of the thread may be defined in a similar manner. Assuming that the thread waited within tasks multiple times during its lifetime and each time the wait started at w_{j, start} and ended at w_{j, end}:

$$WaitTimeOfThread ( {C}_{prev} , {C}_{cur} ) = {\sum }_{j} ( max ( min ( {w}_{\{ j , end \}} , {C}_{cur} ) , {C}_{prev} ) - min ( max ( {w}_{\{ j , start \}} , {C}_{prev} ) , {C}_{cur} ) )$$

The sum is a sum over all waiting instances. In some instances, there might be multiple waits within a single task.

The thread active time then becomes:

ActiveTimeOfThread (Cprev, Ccur)=ElapsedTimeOfThread (Cprev, Ccur)−WaitTimeOfThread (Cprev, Ccur). The ratio

$$\frac{ActiveTimeOfThread ( {C}_{prev} , {C}_{cur} )}{{C}_{cur} - {C}_{prev}}$$

may be used to determine a ratio or percentage of time the worker was active within a time interval.

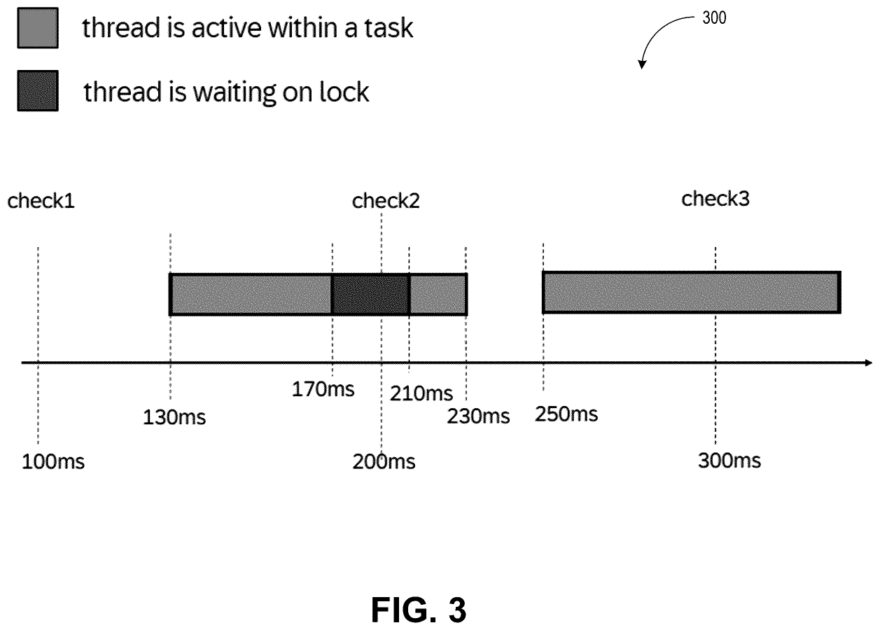

In this respect, FIG. 3 depicts a timestamp graph 300 illustrating a waiting situation in accordance with some example embodiments. In one example, progress is checked at 200 ms (check 2). Thread t starts at 130 ms. At time 200 ms, a worker manager may ask the thread for the active time so far. The thread calculates the active time so far (up to 200 ms) as: elapsed (70 ms)−wait time (30 ms)=40 ms in total and resets its internal timers to be ready for the next check. The total time since the last check is 200-100 ms=100 ms. Therefore, the worker was active for only 40/100 or 40% of the interval.

In another example, progress is checked at 300 ms (check 3). Thread t has accumulated since the last check elapsed time: (230−200=30)+(300−250=50)=80 ms. It has also accumulated a wait time of 210−200=10 ms. The active time is then 80−10=70 ms. The total time since the last check is 300−200 ms=100 ms. Therefore, the worker was active for only 70/100 or 70% of the interval.

Returning to FIG. 2, at step 210, adaptive task scheduling computing platform 110 may determine a ratio of the thread active time and the elapsed time (e.g., thread_active_time/manager_between_checks_duration).

At step 212, adaptive task scheduling computing platform 110 may adaptively configure a number of threads for executing the task queue based on the ratio. In some implementations, adaptively configuring the number of threads for executing the task queue may include multiplying the ratio by a number of threads working in the task queue and a maximum workers factor. The maximum workers factor may be a configuration parameter that is determined based on a progress that is made since the last check of periodic checks into the task queue. The maximum workers factor may take values between 1 and some max_workers_factor (which by default is 2). In some examples, additional threads for executing the task queue may be requested. In some examples, the number of threads utilized for executing the task queue may be kept as is (e.g., without increasing/adding or decreasing/reducing the number of threads).

In one non-limiting example, assume adaptive task scheduling computing platform 110 (e.g., via worker manager server 120) performs checks into a queue at timestamp “0” and at timestamp “100”. In this case, the manager_between_checks_duration would be equal to 100 (i.e., 100 minus 0). Assume there are 100 workers that are active the last time a check was performed and there are not enough workers. When the workers have been active “20” out of “100” of the time (i.e., only 20% of the time), practically, there were only 20 workers. In a more naive method, the original number of workers (e.g., 100) would be doubled (e.g., to 200, assuming a default max_workers_factor of 2). However, in an example implementation herein, the number of workers would not increase so rapidly. That is, aspects of the disclosure do not just check how many workers have been working in a specific queue and multiplies them with a factor if the progress was not enough. Instead, for each one of the workers, aspects of the disclosure take into account the extent to which each one actually worked (e.g., was active) within a time frame.

Instead, adaptive task scheduling computing platform 110 may adaptively configure a number of threads for executing the task queue based on the ratio of thread_active_time/manager_between_checks_duration, or 20/100. For example, this ratio (e.g., 20/100=0.2) would be multiplied by a number of threads working in the task queue (e.g., 100) and a maximum workers factor (e.g., default being 2). The resulting value would be 40 additional workers (i.e., 0.2×100×2=40). Because adaptive task scheduling computing platform 110 does not remove workers from the system, adaptive task scheduling computing platform 110 will keep the 100 workers as they are, and not increase the number of workers in such a waiting situation.

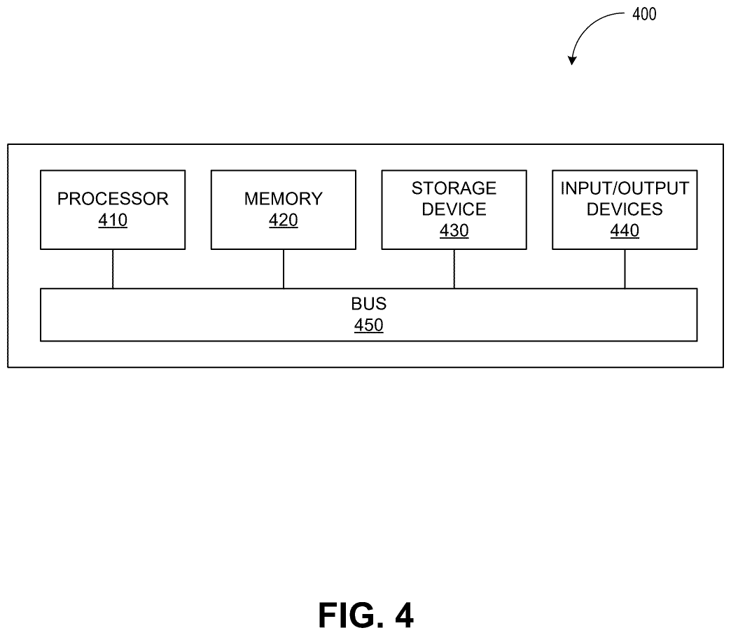

FIG. 4 depicts a block diagram illustrating a computing system 400 consistent with implementations of the current subject matter. Referring to FIGS. 1-4, the computing system 400 can be used to implement the adaptive task scheduling computing platform 110 and/or any components therein.

As shown in FIG. 4, the computing system 400 can include a processor 410, a memory 420, a storage device 430, and input/output devices 440. The processor 410, the memory 420, the storage device 430, and the input/output devices 440 can be interconnected via a system bus 450. The processor 410 is capable of processing instructions for execution within the computing system 400. Such executed instructions can implement one or more components of, for example, the adaptive task scheduling computing platform 110. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a solid-state device, a floppy disk device, a hard disk device, an optical disk device, a tape device, and/or any other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising:
at least one processor; and
at least one memory storing instructions, which when executed by the at least one processor, result in operations comprising:
   determining a number of tasks that have been processed since a last check of periodic checks into a task queue; and
   in response to determining that a progress threshold has not been reached based on the number of tasks that have been processed:
      determining, for a thread working in the task queue, a thread active time comprising an accumulated time the thread was actively executing a task since the last check of the periodic checks into the task queue;
      determining, for the thread working in the task queue, an elapsed time since the last check of periodic checks into a task queue;
      determining a ratio of the thread active time and the elapsed time; and
   adaptively configuring a number of threads for executing the task queue based on the ratio.

Example 2: The system of Example 1, wherein adaptively configuring the number of threads for executing the task queue comprises multiplying the ratio by a number of threads working in the task queue and a maximum workers factor.

Example 3: The system of any of Examples 1-2, wherein the maximum workers factor is determined based on a progress that is made since the last check of periodic checks into the task queue.

Example 4: The system of any of Examples 1-2, wherein the maximum workers factor is two.

Example 5: The system of any of Examples 1-4, wherein the task queue comprises a list of tasks with one or more threads to service the list.

Example 6: The system of any of Examples 1-5, wherein the thread active time comprises a difference between the elapsed time since the last check of periodic checks into a task queue and a wait time.

Example 7: The system of any of Examples 1-6, further comprising: resetting the thread active time for the thread.

Example 8: The system of any of Examples 1-7, wherein one or more tasks in task queue comprises a thread that is waiting on a lock.

Example 9: The system of any of Examples 1-8, wherein adaptively configuring the number of threads for executing the task queue comprises requesting additional threads for executing the task queue.

Example 10: The system of any of Examples 1-9, wherein adaptively configuring a number of threads for executing the task queue comprises keeping the number of threads as is.

Example 11: A computer-implemented method comprising:
determining a number of tasks that have been processed since a last check of periodic checks into a task queue; and
in response to determining that a progress threshold has not been reached based on the number of tasks that have been processed:
   determining, for a thread working in the task queue, a thread active time comprising an accumulated time the thread was actively executing a task since the last check of the periodic checks into the task queue;
   determining, for the thread working in the task queue, an elapsed time since the last check of periodic checks into a task queue;
determining a ratio of the thread active time and the elapsed time; and
adaptively configuring a number of threads for executing the task queue based on the ratio.

Example 12: The computer-implemented method of Example 11, wherein adaptively configuring the number of threads for executing the task queue comprises multiplying the ratio by a number of threads working in the task queue and a maximum workers factor.

Example 13: The computer-implemented method of any of Examples 11-12, wherein the maximum workers factor is determined based on a progress that is made since the last check of periodic checks into the task queue.

Example 14: The computer-implemented method of any of Examples 11-12, wherein the maximum workers factor is two.

Example 15: The computer-implemented method of any of Examples 11-14, wherein the task queue comprises a list of tasks with one or more threads to service the list.

Example 16: The computer-implemented method of any of Examples 11-15, wherein the thread active time comprises a difference between the elapsed time since the last check of periodic checks into a task queue and a wait time.

Example 17: The computer-implemented method of any of Examples 11-16, further comprising: resetting the thread active time for the thread.

Example 18: The computer-implemented method of any of Examples 11-17, wherein one or more tasks in task queue comprises a thread that is waiting on a lock.

Example 19: The computer-implemented method of any of Examples 11-18, wherein adaptively configuring the number of threads for executing the task queue comprises requesting additional threads for executing the task queue.

Example 20: A non-transitory computer-readable medium storing instructions, which when executed by at least one processor, result in operations comprising:
determining a number of tasks that have been processed since a last check of periodic checks into a task queue; and
in response to determining that a progress threshold has not been reached based on the number of tasks that have been processed:
   determining, for a thread working in the task queue, a thread active time comprising an accumulated time the thread was actively executing a task since the last check of the periodic checks into the task queue;
   determining, for the thread working in the task queue, an elapsed time since the last check of periodic checks into a task queue;
determining a ratio of the thread active time and the elapsed time; and
adaptively configuring a number of threads for executing the task queue based on the ratio.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system comprising:
at least one processor; and
at least one memory storing instructions, which when executed by the at least one processor, result in operations comprising:
determining a number of tasks that have been processed since a last check of periodic checks into a task queue; and
in response to determining that a progress threshold has not been reached based on the number of tasks that have been processed:
determining, for a thread working in the task queue, a thread active time comprising an accumulated time the thread was actively executing a task since the last check of the periodic checks into the task queue;
determining, for the thread working in the task queue, an elapsed time since the last check of periodic checks into a task queue;
determining a ratio of the thread active time and the elapsed time; and
adaptively configuring a number of threads for executing the task queue based on the ratio.

2. The system of claim 1, wherein adaptively configuring the number of threads for executing the task queue comprises multiplying the ratio by a number of threads working in the task queue and a maximum workers factor.

3. The system of claim 2, wherein the maximum workers factor is determined based on a progress that is made since the last check of periodic checks into the task queue.

4. The system of claim 2, wherein the maximum workers factor is two.

5. The system of claim 1, wherein the task queue comprises a list of tasks with one or more threads to service the list.

6. The system of claim 1, wherein the thread active time comprises a difference between the elapsed time since the last check of periodic checks into a task queue and a wait time.

7. The system of claim 1, further comprising: resetting the thread active time for the thread.

8. The system of claim 1, wherein one or more tasks in task queue comprises a thread that is waiting on a lock.

9. The system of claim 1, wherein adaptively configuring the number of threads for executing the task queue comprises requesting additional threads for executing the task queue.

10. The system of claim 1, wherein adaptively configuring a number of threads for executing the task queue comprises keeping the number of threads as is.

11. A computer-implemented method comprising:
determining a number of tasks that have been processed since a last check of periodic checks into a task queue; and
in response to determining that a progress threshold has not been reached based on the number of tasks that have been processed:
determining, for a thread working in the task queue, a thread active time comprising an accumulated time the thread was actively executing a task since the last check of the periodic checks into the task queue;
determining, for the thread working in the task queue, an elapsed time since the last check of periodic checks into a task queue;
determining a ratio of the thread active time and the elapsed time; and
adaptively configuring a number of threads for executing the task queue based on the ratio.

12. The computer-implemented method of claim 11, wherein adaptively configuring the number of threads for executing the task queue comprises multiplying the ratio by a number of threads working in the task queue and a maximum workers factor.

13. The computer-implemented method of claim 12, wherein the maximum workers factor is determined based on a progress that is made since the last check of periodic checks into the task queue.

14. The computer-implemented method of claim 12, wherein the maximum workers factor is two.

15. The computer-implemented method of claim 11, wherein the task queue comprises a list of tasks with one or more threads to service the list.

16. The computer-implemented method of claim 11, wherein the thread active time comprises a difference between the elapsed time since the last check of periodic checks into a task queue and a wait time.

17. The computer-implemented method of claim 11, further comprising: resetting the thread active time for the thread.

18. The computer-implemented method of claim 11, wherein one or more tasks in task queue comprises a thread that is waiting on a lock.

19. The computer-implemented method of claim 11, wherein adaptively configuring the number of threads for executing the task queue comprises requesting additional threads for executing the task queue.

20. A non-transitory computer readable medium storing instructions, which when executed by at least one processor, result in operations comprising:
determining a number of tasks that have been processed since a last check of periodic checks into a task queue; and
in response to determining that a progress threshold has not been reached based on the number of tasks that have been processed:
determining, for a thread working in the task queue, a thread active time comprising an accumulated time the thread was actively executing a task since the last check of the periodic checks into the task queue;
determining, for the thread working in the task queue, an elapsed time since the last check of periodic checks into a task queue;
determining a ratio of the thread active time and the elapsed time; and
adaptively configuring a number of threads for executing the task queue based on the ratio.
